(19) United States
(12) Patent Application Publication
(10) Pub. No.: US 2012/0099594 A1
(43) Pub. Date: Apr. 26, 2012

(54) MEDIA DISTRIBUTION ARCHITECTURE

(75) Inventors: Dannie Lau, Santa Clara, CA (US); Chun Ho Lee, La Crescenta, CA (US)

(73) Assignee: PHORUS LLC, Encino, CA (US)

(21) Appl. No.: 13/278,799

(22) Filed: Oct. 21, 2011

Related U.S. Application Data
(60) Provisional application No. 61/405,835, filed on Oct. 22, 2010.

(51) Int. Cl. H04L 12/56

(52) U.S. Cl. 370/392

(57) ABSTRACT

A wired and wireless media transport technology is provided that allows for the simultaneous transmission of media to multiple zones while maintaining precise timing synchronization. A user can have a network of speakers, and independently select which ones are actively playing and have their playback synchronized. The media source can be a cell phone, tablet, stereo, set-top box, PC or other device. The media itself can be audio or video. The transmission method of media into the network can be wired, as through an auxiliary cable, or wireless as with Bluetooth or WiFi. The speakers/endpoints themselves are governed in a self-forming network. Audio is injected into the network from a source and the end-point network itself controls audio/video distribution, timing, and rendering.

### PRIORITY

This application claims the benefit of U.S. Provisional Application No. 61/405,835, entitled “Media Distribution Architecture,” by Lau et al., filed on Oct. 22, 2010, incorporated herein by reference.

### BACKGROUND

People use their cellular telephones (e.g., iPhone, Droid, etc.) and other electronic devices to play content, such as music or videos. Herein, a device that provides media is referred to as a “media source device.” Other media source devices include a tablet computer, a laptop computer, a personal computer, etc. The user may have an application such as an MP3 player, a Web Browser, a media player, etc. that allows them to play media that is either stored locally or retrieved from another source, such as the Internet.

Often media source devices do not render the media adequately. For example, the display on a cellular telephone may be too small or the speaker may not be of sufficient quality or volume. Moreover, output of the media source device may not be easily viewable or listenable to more than one person. Furthermore, absent carrying the media source device with them, the user is unable to enjoy the media in various locations throughout their home.

It would be beneficial to the user to be able to view or listen to media content anywhere in their home or other environment. It would be beneficial to the user to be able to selectively choose exactly where the media is rendered. It would also be beneficial if the solution worked with whatever application runs on the media source device in order to play the media.

### BRIEF DESCRIPTION OF THE DRAWINGS

FIG. 1 shows an example environment in which embodiments may be practiced.

FIG. 2 is a flowchart that describes one embodiment of a process of forming and operating a virtual media network.

FIG. 3A-FIG. 3G depict examples of different virtual media networks that a user might establish using embodiments.

FIG. 4 is a flowchart of one embodiment of a network discovery process.

FIG. 5A is a flowchart of one embodiment of a process pairing a media source device with a gateway media node.

FIG. 5B is a diagram of one embodiment of messages used when pairing a media source device with a gateway media node.

FIG. 6A is a flowchart describing one embodiment of a process for adding more media nodes to a virtual media network.

FIG. 6B is a diagram of one embodiment of messages used when linking a new node to a virtual media network.

FIG. 7A is a block diagram of one embodiment of a media node.

FIG. 7B is a block diagram of one embodiment of a media source device.

FIG. 7C is one embodiment of a media source device in which both the audio signal and the commands are sent using the same network protocol.

FIG. 7D depicts a block diagram of one embodiment of a media source device in which a media source application is embedded into the virtual network media application.

FIG. 8 is a flowchart of one embodiment of sending a media signal and commands from a media source device to a media node.

FIG. 9 is a flowchart of one embodiment of sending a media signal and commands from a media source device to a media node.

FIG. 10 is a flowchart of one embodiment of sending a media signal and commands from a media source device to a media node.

FIG. 11A is a flowchart of one embodiment of gateway broadcasting a media signal.

FIG. 11B is a flowchart of one embodiment of a media source node sending the media signal to the gateway using the native format of the media signal.

FIG. 11C is a flowchart of one embodiment in which the media source device instruments the native format.

FIG. 12 is a block diagram of an example computing system that can be used to implement the technology described herein.

### DETAILED DESCRIPTION

The technology described herein provides an architecture for distributing media content. A wired and wireless media transport technology is provided that allows for the simultaneous transmission of media to multiple zones while maintaining precise timing synchronization. A user can have a network of speakers, and independently select which ones are actively playing and have their playback synchronized. This network of speakers is referred to herein as a virtual media network. Note that the media signal itself can be audio or video. Therefore, the virtual media network may include display devices.

The media source device can be a cell phone, tablet, stereo, set-top box, PC or other device. The transmission method of media into the network can be wired, as through an auxiliary cable, or wireless as with Bluetooth or WiFi. The speakers themselves may be governed in a self-forming network. Audio may be injected into the network from media source device and the end-point network itself controls audio/video distribution, timing, and rendering. In one embodiment, the audio that is injected into the network is the audio portion of an audio-video signal. The video signal may be played on the media source device (e.g., tablet computer). Note that the audio signal may be kept in sync with the video signal.

In one embodiment, a user can select any media application to serve as a source of the media. For example, the user could select an MP3 application, an Internet radio application, etc. The user then simply selects an output device, such as a speaker in their living room, to cause the media to be sent to the selected output device. The audio may be sent to the selected output device by the operating system. The user can call up a second application to add other speakers to the virtual media network, as well as to control volume of the speakers, etc. The second application never touches the audio, in one embodiment. The devices in the network may handle the audio/video distribution, timing, and rendering. Therefore, the media source device is not burdened with this processing. Moreover, note that this solution allows the user to select whatever media application they like as the source of the media. No modifications are needed to the media source application.

The following definitions will be used throughout this description:

Broadcaster—Any device that can transmit a media stream that is formatted for the virtual media network. May also refer to a broadcasting mechanism within the device.

Renderer—Any device that can render a media stream that is formatted for the virtual media network. May also refer to a rendering mechanism within the device.

Media Node—Any device that contains a renderer or a broadcaster. Nodes of one embodiment are responsible for maintaining network time synchronization and the state of the network including media routing information.

Media source device—Any device that transmits original media to a sink.

Sink—Any device that receives originating media from a source. May also refer to a mechanism within the device for receiving a media signal.

Gateway Capable Media Node—Any device that combines a sink and broadcaster. Gateways accept media from a sink and re-broadcast into the virtual media network to renderers.

Virtual Media Network—A group of one or more nodes having at least one gateway. A virtual media network may be established by a user and renders a media signal that is synchronized between all rendering devices in the network. Note that only one media node serves as an active gateway in one embodiment of a virtual media network.

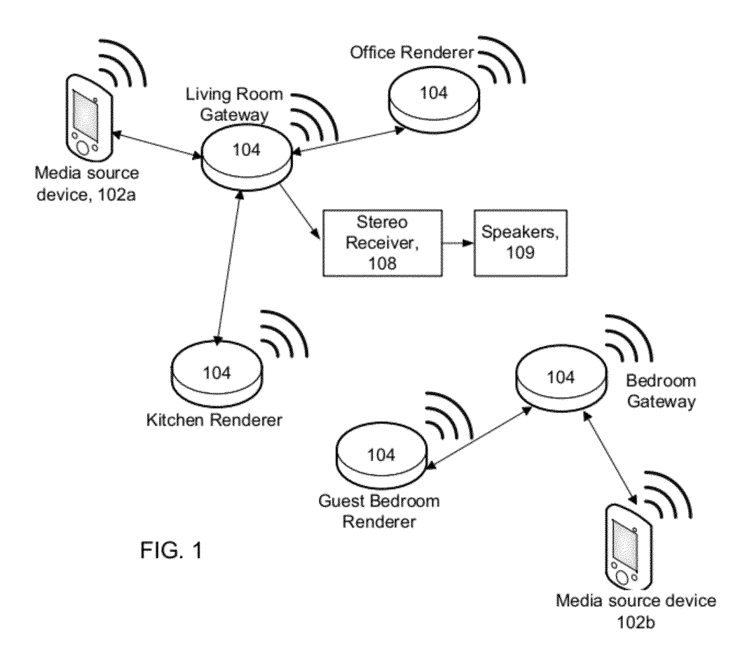

FIG. 1 shows an example environment in which embodiments may be practiced. There are a total of five network media nodes 104 in this example. Presently, there are two virtual media networks. Media source device 102a serves as a source for a media signal for one virtual media network, whereas media source device 102b serves as a media source for another virtual media network. The media signal may be audio or video. In one embodiment, the media signal is the audio portion of an audio-video signal. The video signal may be played on the media source device 102 (e.g., tablet computer, cellphone, etc.). Note that the audio signal may be kept in sync with the video signal. Also note that the video signal could be sent to one of the devices in the virtual media network, or some device other than the media source node 102. A media source device 102 can be a cellular telephone, tablet computer, stereo system, set-top box, Personal Computer (PC) or other device. Each virtual media network has one gateway device, in one embodiment. As noted above, a gateway device has a sink for receiving a media signal and a broadcaster. A gateway device may or may not have a renderer for rendering audio and/or video. Presently, a device in the living room serves as a gateway; however, a different device having a broadcaster may act as the gateway.

In one embodiment, the system allows for simultaneous transmission of media to multiple zones while maintaining precise timing synchronization. As one example, a user can have a network of speakers, independently select which ones are actively playing and have their playback synchronized. The transmission method of media into the network can be wired, as through an auxiliary cable, or wireless as with Bluetooth, WiFi or another network communication protocol. As one example, the living room gateway may have an auxiliary out line to provide the media signal to the stereo receiver by one of its auxiliary in lines. On the other hand, the living room gateway may provide the media signal to the office renderer and the kitchen renderer via wireless transmission. Thus, note that the living room gateway may or may not have its own renderer.

The media nodes 104 themselves may be governed in a self-forming network, in one embodiment. Note that the media nodes 104 themselves may control audio/video distribution, timing, and rendering. Therefore, much of the processing load is removed from the media source device 102. Therefore, a device such as a cellular telephone, which may have limited processing power, is not burdened. The example of FIG. 1 pertains to a home environment, but embodiments are not so limited.

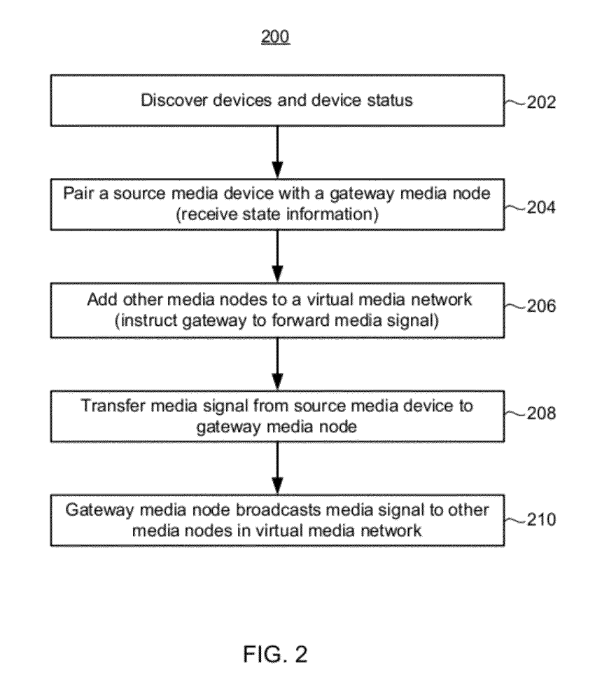

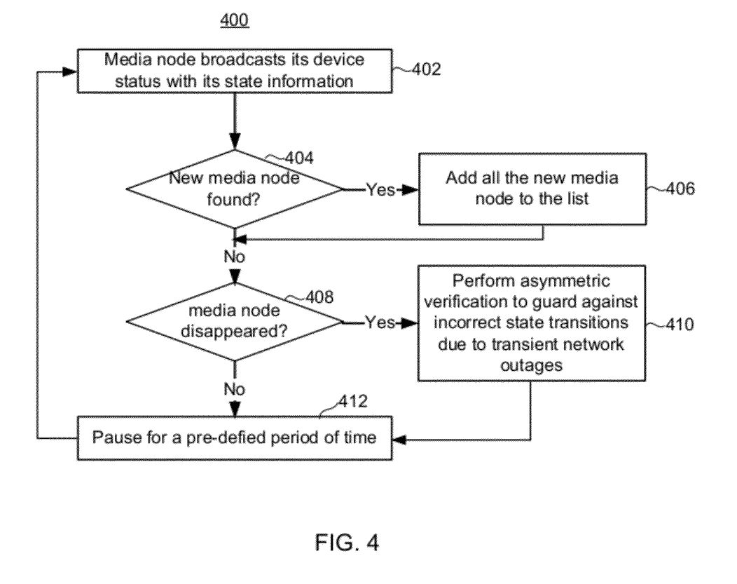

FIG. 2 is a flowchart that describes one embodiment of a process 200 of forming and operating a virtual media network. Reference to FIG. 1 will be made when describing process 200. In step 202, devices a discovered and device status is exchanged. Step 202 may occur when media nodes 104 are powered on. Since media nodes 104 may be powered on at different times, this step may be ongoing. In one embodiment, the media nodes 104 perform a “self-discovery” protocol in which the media nodes 104 learn of each other's existence and their capabilities. Note that the device status may include whether the device is currently active in a virtual media network, whether it is currently acting as a gateway, etc. Further details of step 202 are discussed with respect to FIG. 4.

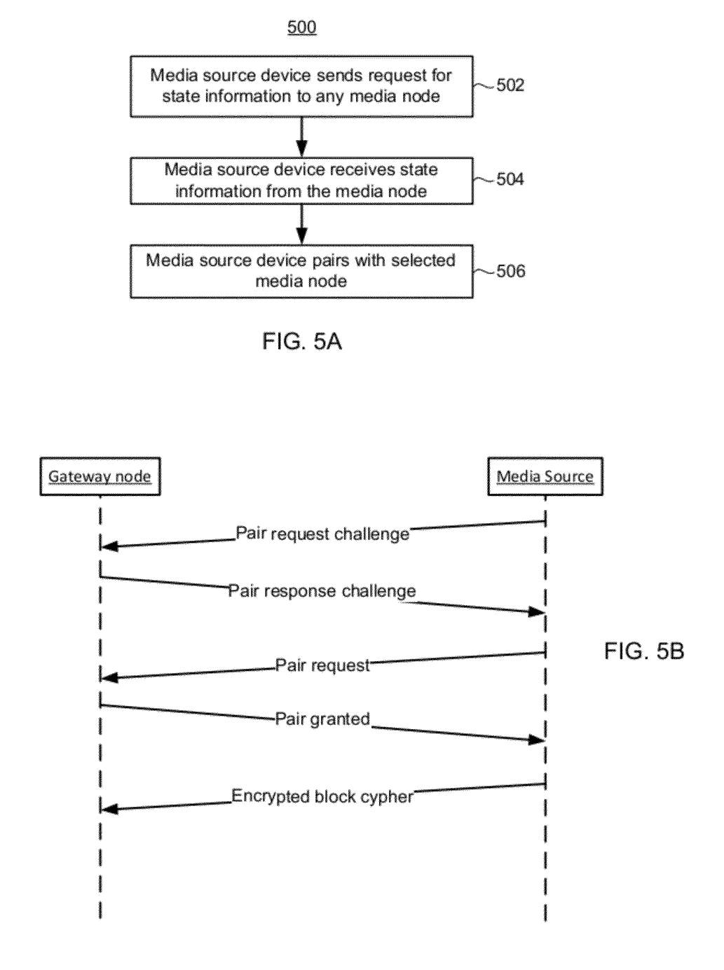

In step 204, a media source device 102 is paired with a gateway media node 104. As noted above, each virtual media network has one gateway media node 104, in one embodiment. A user may specifically select one media node 104, which will serve as the gateway, or the gateway may be determined automatically without user intervention. For example, the user of smartphone 102a may select the living room media node as a primary listening device, which results in it becoming the gateway. In one embodiment, the gateway media node is selected based on its status as a currently active output device for the media source node 102. In one embodiment, the gateway media node serves as an active output device for the media source node 102 while acting as the gateway. In one embodiment, the gateway media node reports the device or state information to the media source device 102. Further details are discussed with respect to FIGS. 5A and 5B.

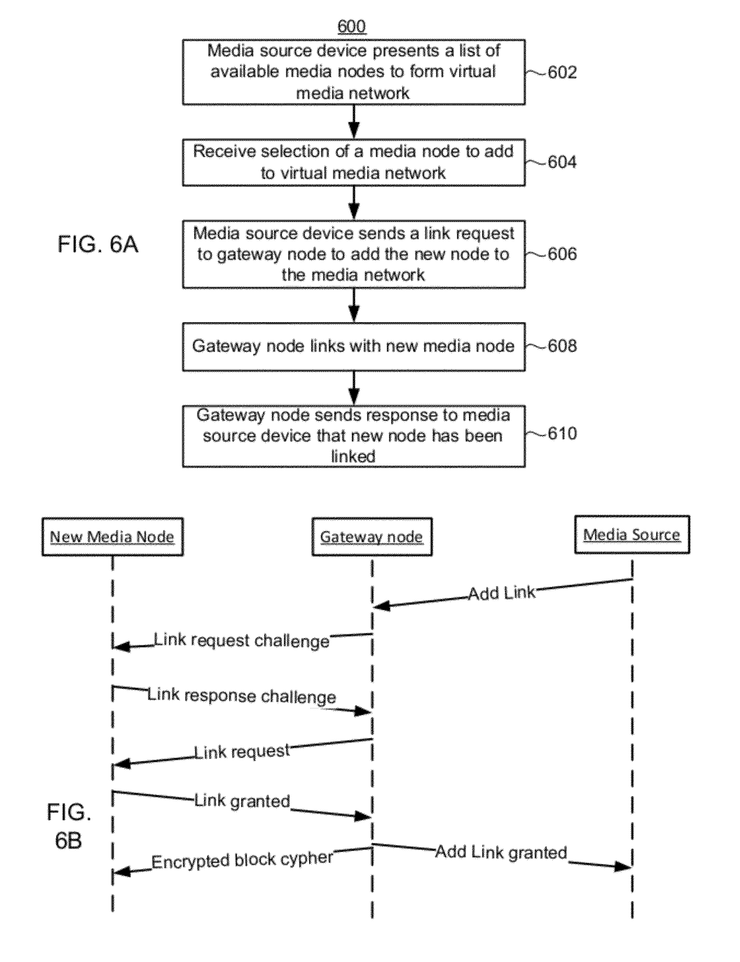

In step 206, a virtual media network is formed. Step 206 may be formed in response to a user selecting media nodes 104. For example, the user accesses a software program on media source dice 102 (e.g., smartphone) that allows the user to select media nodes 104. Note that if a media node 104 is already a part of a different virtual media network, this media node 104 might be indicated as unavailable. Alternatively, the user might be allowed to request that this media node 104 be freed up. In one embodiment, step 206 results in instructing the gateway media node 104 to forward the media signal to other media nodes 104 in the virtual media network. Further details are discussed with respect to FIGS. 6A and 6B.

In step 208, media is transferred from the media source device 102 to the gateway media node 104. This step 208 could be initiated in response to a user selecting that media be presented on an output device associated with the media source. For example, the user could have any application running on the smartphone 102a that plays media. The user simply selects the gateway media node 104 as the output device and the media is transferred to the gateway media node 104. Note that this media transfer could happen at the operating system (O/S) level. An implication of this transfer is that any media application can be selected by the user as the media source for the virtual media network.

In step 210, the gateway media node 104 broadcasts the media signal to other media nodes 104 in the virtual media network. For example, the living room gateway broadcasts the media signal it received from smartphone 102a to office renderer and kitchen renderer. Note that each media node 104 may play the media at its own user-controllable level (e.g., volume). Thus, there may be some commands sent from the media source device 102 to the gateway media node 104. However, the gateway may perform much, if not most of the processing. Therefore, the media source device 102 is not bogged down with a heavy processing load.

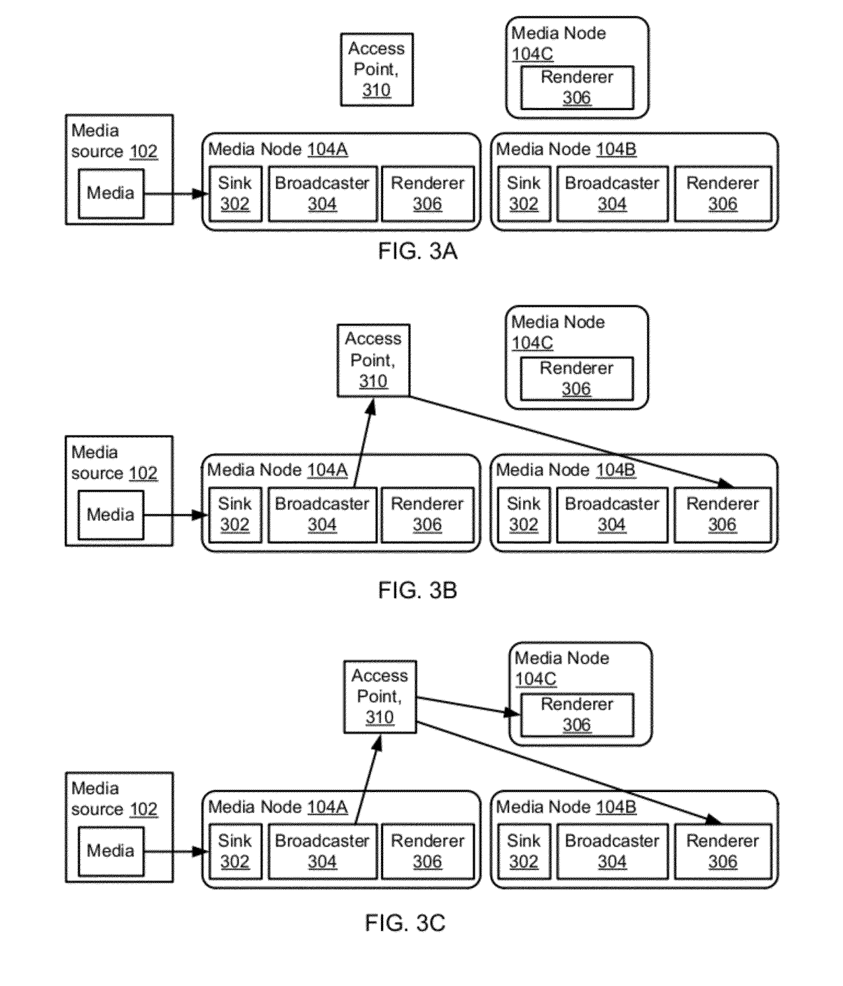

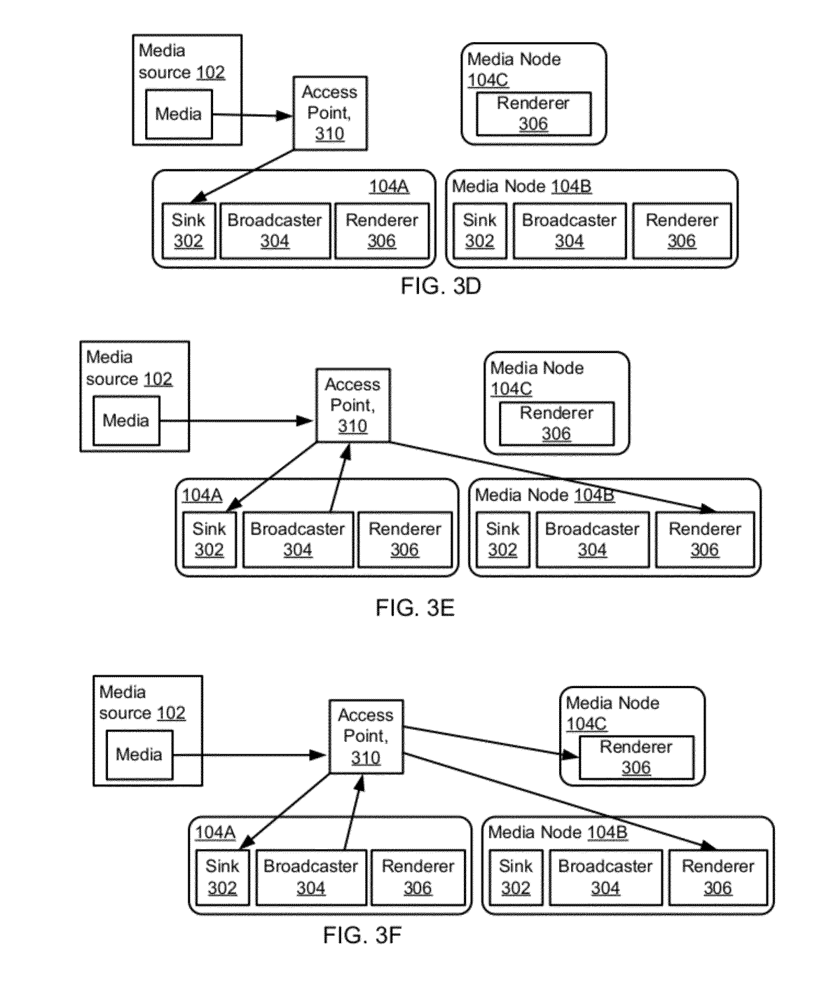

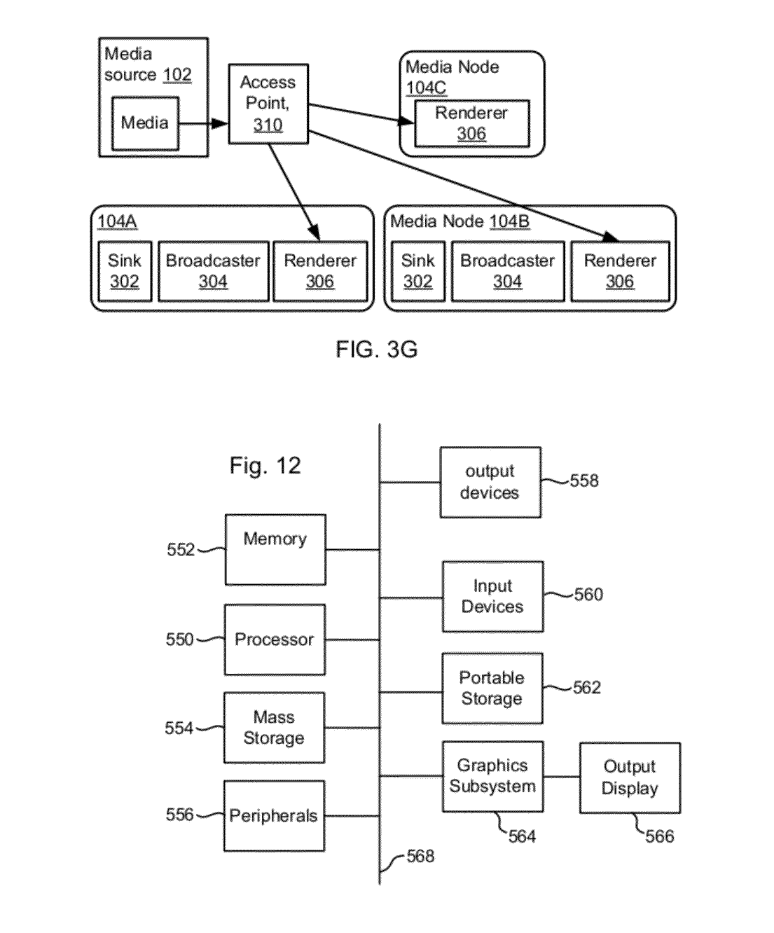

FIG. 3A-3G depict various examples of different virtual media networks that a user might establish. In FIGS. 3A-3G, there are two media nodes 104 that are capable of serving as a gateway because they have a sink 302 for receiving a media signal and a broadcaster 304 for proving the media signal to another media node 104. Note that at any one time only one of the devices acts as a gateway in a given virtual media network. For the sake of illustration, there is an access point 310 that is separate from the media nodes 104. Note that one of the media nodes 104 may act as an access point.

Some of the media nodes 104 include a broadcaster 304. Such nodes may be referred to herein as broadcasting nodes. A broadcaster 304 may be implemented by any combination of hardware and/or software. In one embodiment, broadcasters 304 transmit media in an airtime broadcast format that is understood by other media nodes 104. Note that this format may be different from the one used to send the media signal from the media source 102. Broadcasters 304 and renderers 306 may co-exist in the same media node 104 so that local playback can be synchronized with playback on remote renderers. Source injection may be done via a source-sink link. Unlike source to sink transmission, airtime broadcasts can be used for point-to-multipoint media transmission with synchronous playback.

As noted, a gateway capable media node 104 has the combination of a sink 302 and a broadcaster 304. In one embodiment, gateways receive media from the media source device 102 and re-broadcast the media in a format that is compatible with the virtual media network. Gateways can also include a renderer 306. In one embodiment, a gateway media node 104 is considered to be an endpoint. FIGS. 3B, 3C, 3E and 3F show gateway renderers in action.

Multiple gateway capable media nodes 104 can exist on the network. In one embodiment, an election method exists to determine the best gateway for a media source device 102 to use. For example, in the event only one media node 104 with a renderer 306 is active for the media source device 102, that rendering node may also be the best gateway, conserving network bandwidth for other sources. On the other hand, if multiple renderers are active for the media source device 102 the best gateway may be the one with the strongest/best network connection. An election scheme may occur to identify the best candidate and, if necessary, a stream handoff may occur to a different gateway in which case the original gateway becomes the source's sink. This can occur during stream construction or mid-stream. In the event that an active gateway is disabled, the network can self-heal and elect a new gateway to re-establish airtime broadcast streams.

Some of the media nodes 104 include a renderer 306. Such media nodes 104 may be referred to herein as rendering nodes. A renderer 306 may be implemented by any combination of hardware and/or software. Renderers 306 can decode and play the media stream through an internally powered speaker, or via analog or digital outs to another amplifier/speaker device, using the example of audio for the media signal. For video, the renderer 306 can decode and play the media stream through an internally powered display, or via analog or digital outs to another display or device having or driving a display. In one embodiment, a media node 104 with a renderer 306 supports the creation, maintenance, and distribution of a virtual wall clock. Renderers 306 may use the wall clock to precisely render the stream at the timestamp specified in the airtime stream format. FIGS. 3C and 3F show renderers 306 in action with other media nodes 104.

A brief discussion will now be provided of different virtual media networks of FIGS. 3A-3G. In FIG. 3A, there is a connection between a media source device 102 to a sink 302 in the gateway media node 104A. The media signal is played by the renderer 306 in gateway media node 104A. To establish the connection, the user may have selected gateway media node 104A as an output device for the media source device 102. For example, the media source device 102 may be a cellular telephone that allows the user to select which speaker to send audio to. Any audio that is being played by the cellular telephone may be sent to the selected speaker. Thus, regardless of what application is providing the audio (e.g., Internet radio, MP3, etc.), the audio will be routed to gateway media node 104A. Note that no changes need to be made to the application that provides the audio for this to happen. The connection between the media source device 102 and gateway media node 104A could be wireless or wired. In one embodiment, it is a wireless Bluetooth connection. However, a wireless protocol other than Bluetooth may be used.

In FIG. 3B, in addition to the connection between media source device 102 and sink 302 in the gateway media node 104A, the broadcaster 304 in media node 104A is used to send the media signal to the renderer 306 in media node 104B. In this example, the access point 310 serves as an intermediary. However, an access point 310 is not a requirement. In one embodiment, media node 104A serves as the access point.

In the example of FIG. 3B, the connection from the media source 102 to media node 104B may have been established in a similar manner to the one in FIG. 3A. The user has also established media node 104B as part of the virtual media network. The media source device 102 may have a software application that allows the user to select which media nodes 104 to add to the virtual network. This application may send commands to media node 104A that instructs it to forward the media signal to the other media nodes 104 that are an active part of the virtual media network. Media node 104A may handle details of reformatting the media signal, routing, synchronizing playback between media nodes, etc. Therefore, the media source 102 is not burdened with heavy processing.

In one embodiment, the broadcaster 304 transmits the media signal using a different network protocol than the one used to send the media signal to it. For example, the media source 102 might send the media signal using a Bluetooth protocol. The broadcaster 304 might reformat this signal and send it using a Wi-Fi protocol.

In the example of FIG. 3C, media node 104C, which contains a renderer 306 is added to the virtual media network. The user may add this media node 104C in a similar manner to adding media node 104B. One or more commands may be sent from media source 102 to gateway media node 104A to add media node 104C to the virtual media network. Again, media node 104C may handle details of adding media node 104C and synchronizing playback. As with FIG. 3B, a separate access point 310 is not a requirement.

In the example of FIG. 3D, the connection from the media source 102 to the media node 104A is made through an access point 310. In one embodiment, the access point 310 is a Wi-Fi access point. However, the access point 310 could use a different protocol. In one embodiment, the access point 310 is a separate physical device from the media node 104A. In one embodiment, the access point 310 is within the media node 104A.

The example of FIG. 3E is similar to FIG. 3D with the additional link to the renderer of media node 104B. The additional link may be set up as discussed with respect to FIGS. 3B and 3C. In one embodiment, the same communication protocol for all transfers of the media signal. For example, a Wi-Fi protocol may be used for all transfers. However, note that a protocol other than Wi-Fi may be used.

The example of FIG. 3F is similar to FIG. 3E with the additional link to the renderer 306 of media node 104C.

In the example of FIG. 3G, the access point 310 is used as the central broadcast point. That is, the media signal is sent from the media source 102 to the access point 310, which broadcasts the media signal to the media nodes 104A-C. In one embodiment, a Wi-Fi protocol is used both for the transfer to and the broadcast from the access point 310. However, note that a protocol other than Wi-Fi may be used.

As previously noted, media source devices 102 inject media into the virtual media network. Examples include a PC or a SmartPhone. Methods of media injection include cables supporting analog or digital transmission, Bluetooth, and WiFi. In one embodiment, the media source 102 can be a broadcaster (as in FIG. 3G), transmitting media data in a format that is compatible with the virtual media network. Often, however, technical limitations may limit the ability of a media source device 102 to broadcast. For example, the security model of many phones prevents audio drivers to be modified by third parties. Also, the media source 102 device itself may not have available processing or network bandwidth. Further, the QoS level for the media source's initial link may require a higher QoS than other endpoints so that at least one endpoint can render to the highest possible fidelity.

Note that many formats and connections may be used for the transmission from media source device 102 to sink 302. A media source 102 can transmit via wire, BT A2DP, or a specific protocol via Wi-Fi to a sink 302, as some non-limiting examples. A WiFi protocol can be designed to give a tradeoff between quality and latency, or to guarantee accuracy. For example, the protocol can detect errors and request retransmission of data. Often this may not be the goal of the broadcast; however, it is important that the media arrives reliably prior to broadcasting. Embodiments disclosed herein maintain compatibility with existing devices. Note that most smartphones support BT and wired connections.

The network is based on standard Wi-Fi infrastructure, in one embodiment. Each media node can connect to an access point 310 where it acquires an IP address via DHCP. Often nodes will not have a UI (display, keyboard entry, etc.) that allows for the entering of a wireless access key. In such cases, WPS-PBC can be used to achieve a connection. Other methods can include ad-hoc mode, whereby the user connects to the endpoint directly from a GUI enabled device and inputs network parameters via a webpage served by the node, or an application page that communicates directly with the node. Another method is for an application running on a phone or other device to communicate with the media node via Bluetooth. An application can prompt the user for which access point to connect to and the corresponding network access code. In one embodiment, the media node 104 is provided a name by the user during this set-up phase.

In the absence of infrastructure such as access points 310, a node can turn itself into a virtual access point. Other nodes can discover the access point 310 and connect to form a private network. WPS-PBC and ad-hoc methods can be used to make secure connections.

FIG. 4 is a flowchart of one embodiment of a network discovery process 400. Process 400 is one embodiment of step 202 of FIG. 2. Process 400 describes the network discovery process from the perspective of one arbitrary media node 104. Each media node 104 may perform a similar process. Process 400 may be performed after a media node 104 has been set up and obtained an IP address.

In step 402, the network media node 104 broadcasts its device status and state information. Step 402 may be performed periodically. The device status and/or state information may include the type of device it is, what capabilities it has, and the amount of processing bandwidth available. Device status and/or state information may also include whether the media node 104 is currently serving as a gateway, whether it is currently part of a virtual media network, its volume level, etc.

In step 404, a new media node is found. In one embodiment, the media node 104 receives device status from other media nodes 104. In one embodiment, step 404 is analogous to step 402, but describes receiving device status, as opposed to providing device status. Typically, media nodes 104 both provide their status and receive status from other media nodes 104.

In step 406, the newly found media node is added to a list. This list may include various device status and state information. The device description could include a name that has been assigned to the newly found device (e.g., kitchen, living room, etc.), its IP address, and its MAC address. The device description may also indicate whether the newly found node has a broadcaster 304, and whether it has a sink 302. Therefore, this information may indicate whether the newly found node 104 has the physical ability to act as a gateway. The device description may further indicate such things as whether it has its own speaker, or whether it has an auxiliary line out to send the media signal to a stereo receiver or the like. The state information for a particular media node 104 may include, but it is not limited to, a virtual network name of which it is a part (which may have been provided to it by a media source), whether it presently has communication links to other devices in a virtual network, volume level. The media node 104 may store information for all of the media nodes 104, such that it can provide the media source 102 with whatever information is necessary. Also, the media node 104 is able to control the virtual media network using this state information. Note that each media node 104 may store the state information such that it is capable of taking over as the gateway media node 104.

From time to time a media node may disappear. If this happens (step 408), then an asymmetric verification is performed in step 410. The asymmetric verification may guard against incorrect state transitions due to transient network outages. Pending the outcome of the asymmetric verification, the media node may be removed from the list.

Step 412 indicates that the media node 104 may pause for a pre-defined period of time before broadcasting its device status again.

FIG. 5 is a flowchart of one embodiment of a process 500 pairing a media source device 102 with a gateway media node 104. Process 500 is one embodiment of step 204 of FIG. 2. Thus, process 500 may be performed after the media nodes 104 have gone through self-discovery. In one embodiment, process 500 is implemented by software running on the media source device 102. This software could be a driver in an O/S or an application that is separate from the O/S. However, the software is not limited to these examples. Process 500 might be initiated when the driver, application, etc. is started. Alternatively, or it might be started in response to selection of one of the media nodes 104 as an output device.

In step 502, the media source device 102 sends a request to a media node 104 for state information. Note that this media node 104 may be one that is being targeted to become the gateway for a virtual media network.

In step 504, the media source device 102 receives the state information from the media node 104. At this time, the virtual media network could include any number of active media nodes 104. However, for the sake of discussion an example will be discussed in which the gateway is the only media node 104 that is active.

In step 506, the media source device 102 pairs with the media node 104. Pairing refers to establishing the media node 104 as a gateway for a virtual media network being served by the media source device 102. Numerous techniques can be used to determine which media node 104 should serve as the gateway. Further details are discussed with respect to FIG. 5B.

FIG. 5B is a diagram of one embodiment of messages passed during an authentication and paring protocol. The authentication and paring protocol involves a media source device 102 and a media node 104. This media node 104 is referred to as the gateway because it is being established as the gateway. As noted earlier, the gateway could be any media node 104 that has the ability to function as a gateway.

The pairing protocol starts with the media source 102 sending a request challenge to the potential gateway media node 104. As the quality of the network is dependent on the information made available from the nodes, a security mechanism exists in one embodiment to prevent un-sanctioned nodes from joining the virtual media network. Media nodes 104 are required to pass a challenge-response query when joining the virtual media network in one embodiment. If a device does not have the proper security keys to complete the challenge-response, it will not be allowed to join the virtual media network. The security mechanism prevents the attachment of counterfeit devices and helps maintain the integrity of the virtual media network.

If the gateway media node 104 responds correctly, then the media source 104 sends a pair request message to the gateway media node 104. The gateway media node 104 determines whether it is able to serve as the gateway. If so, in it sends a grant response to indicate that it will serve as a gateway. If it cannot serve as the gateway it indicates this in its response.

Assuming that the pairing was granted, the media source device 102 sends an encrypted block cypher. Media streams can be optionally encrypted prior to transmission preventing streams from being sniffed from the network. The media source device 102 may now send encrypted audio to the gateway media node 104.

Referring back to FIG. 2, after the gateway media node 104 is paired with the media source device 102, other media nodes 104 may be added to the virtual media network. FIG. 6A is a flowchart describing one embodiment of a process 600 for adding more media nodes 104 to a virtual media network. Various steps of process 600 may be performed by various devices, as will be pointed out during discussion.

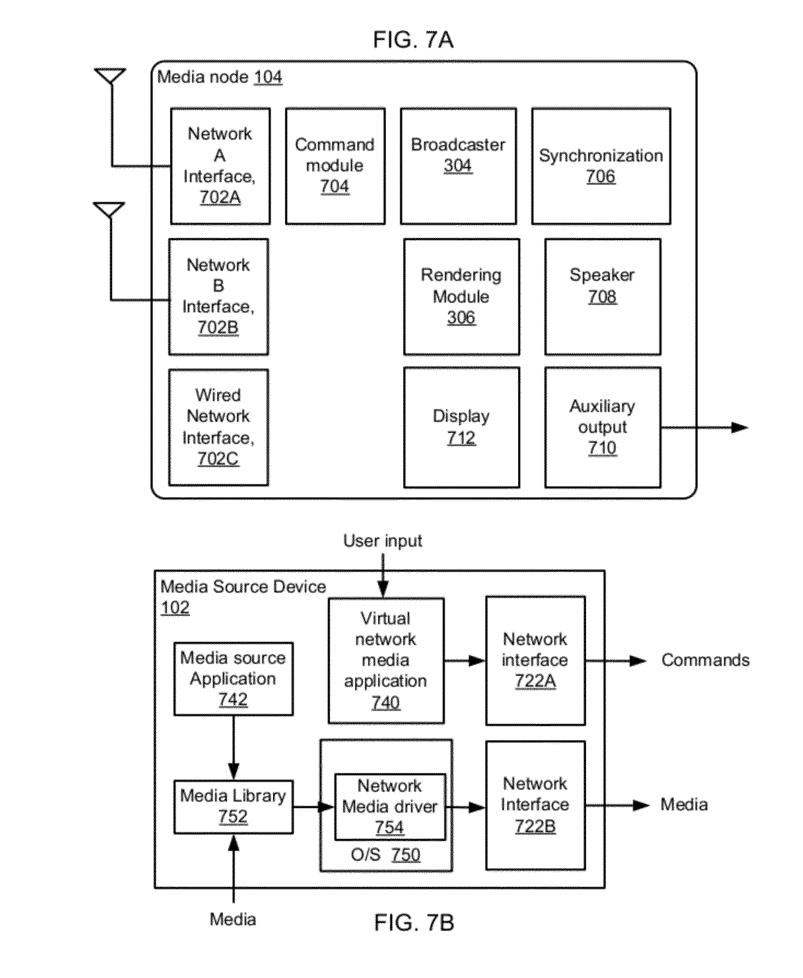

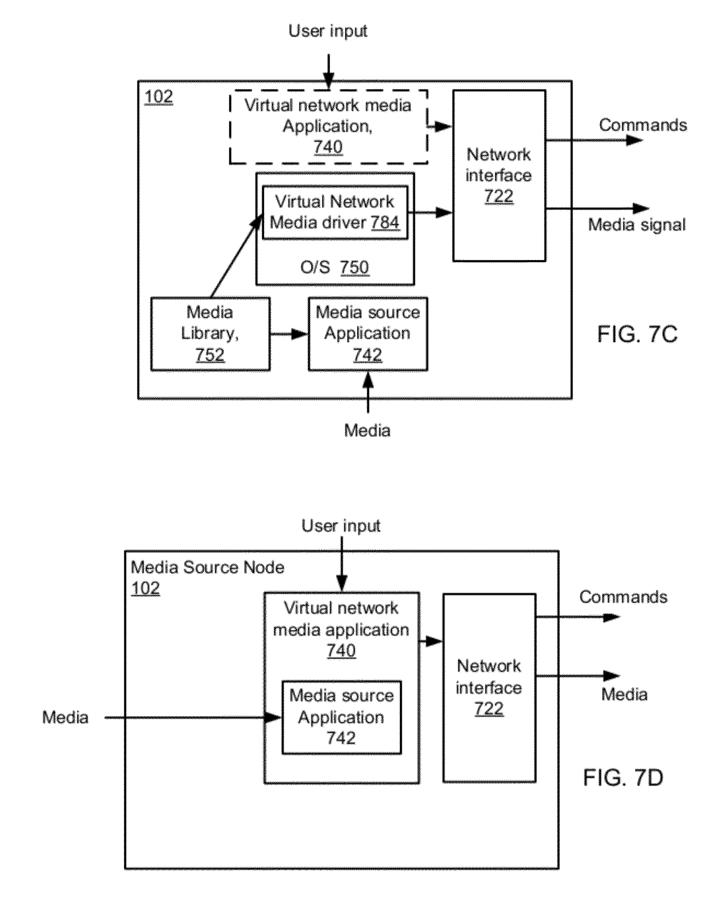

In step 602, the media source device 102 presents a list of available media nodes 104 to add to the virtual media network. This list may be based on the state information that was received in process 500. Step 602 may be performed by a virtual media network application (FIG. 7B-7D, 740) on the media source device 102, as one example.

In step 604, a selection of a media node 104 is received. This may be received by the virtual media network application 740. As one example, the user selects the bedroom speaker.

In step 606, the media source device 102 sends a link request to the gateway media node 104 to add the new media node 104 to the virtual media network. In one embodiment, virtual media network application 740 sends the link request.

In step 608, the gateway media node 104 links with the new node 104. In step 610, the gateway media node 104 sends back the response to the media source 102 that the new node has been linked. The user is able to add any number of media nodes to the virtual media network by selection of additional media nodes 104.

FIG. 6B is a diagram of one embodiment of messages passed when adding a new media node 104 to the virtual network. The scheme involves a media source device 102, a gateway media node 104, and a new media node 104.

The protocol starts with the media source 102 sending an add link request to the gateway media node 104. This request may identify the potential new media node 104 using any of the state information that is stored at the gateway media node 104, in one embodiment. The new node might be identified by speaker name, MAC address, IP address, etc.

Similar to how a gateway node may need to pass a challenge-response query when joining the network in one embodiment, the new media node 104 may also be required to do so. Thus, the gateway node 104 sends a request challenge to the potential new media node 104. If the node media node 104 responds correctly, then the gateway media node 104 sends a link request message to the new media node 104. The new media node 104 may determine whether it is able to take part in the virtual media network. For example, if it is already in another virtual media network it may decline the invitation to join the network, in one embodiment. If it decides to join, it sends a link granted response.

Assuming that the link was granted, the gateway media node 104 informs the media source device 102 that the link was granted. Also, the gateway media node 104 may send an encrypted block cypher to the new media node 104. This may or may not be the same cypher that the gateway was sent from the media source device 102. Note that the gateway media node 104 may use a different encryption than is used by the media source device 102. The gateway media node 104 may now send encrypted audio to the new media node 104.

FIG. 7A is a block diagram of one embodiment of a media node 104. The media node 104 has wireless network interface 702A and wireless network interface 702B. In one embodiment an antenna is connected to each wireless network interface 702. Wireless network interface A could be Wi-Fi compliant and wireless network interface B could be Bluetooth compliant. However, they could be compliant with any other protocols. In one embodiment, there are one or more wireline network interfaces 702C.

The rendering module 306 is responsible for processing the media signal for presentation on the speakers or other output device. Optionally, the media node 104 has or is connected to a video display 712. In this case, the rendering module is responsible for processing the media signal for presentation on the display. The rendering module may receive the media signal from any of the network interfaces.

The broadcasting module 304 is able to forward a media signal to appropriate media nodes 104. The auxiliary output may be used to provide a media signal to a device such as a home stereo system. In one embodiment, the broadcaster 304 handles forwarding media signals to the auxiliary output.

The command module is able to process commands to control the media signal. These commands could include volume, play, pause, etc. The synchronization module is responsible for precise synchronization of the media signal during playback on the various media nodes in the network.

Media nodes 104 can be controlled through a variety of mechanisms. Controllers can include a SmartPhone App, Tablet App, a UI on a TV or set-top box, buttons with or without a display on the node, or a PC app. In one embodiment, these devices can control whether a renderer 306 renders a particular stream, the volume output of the renderer 306, and a master volume.

In one embodiment, all media nodes 104 support a command protocol. The command protocol may include methods to turn on/off audio playback, aggregate audio playback into synchronized zones, transport controls such as play, forward, reverse, and seek, metadata transmission to nodes, announcement of network state to devices joining the network, updates of state when devices leave the network, control via remote user interfaces, and other messages and method to maintain the airtime network.

Note that the elements of the media node 104 may be implemented with software, hardware, or a combination of software and hardware. The media node 104 may have one or more processors and computer readable storage media with instructions thereon, which when executed on the one or more processors, implement functionality of various elements of the media node 104. An example device having a processor and computer storage is discussed later.

FIG. 7B is a block diagram of one embodiment of a media source device 102. The media source device 102 includes two wireless network interfaces. Wireless network interface 722A could be Wi-Fi compliant and wireless network interface 722B could be Bluetooth compliant. However, they could be compliant with any other protocols. In this example, the media signal (e.g., audio stream or video stream) may be sent using network interface 722B. Network interface 722A could be used to send commands for controlling the virtual media network.

A user can access the virtual network media application 740 to control the virtual media network. As one example, the virtual network media application 740 may present a user interface to allow the user to select media nodes 104, control their volume, playback etc. In one embodiment, there is a master volume for the network and individual volumes for each media node 104.

The media source application 742 could be any application that is capable of playing audio on the media source device 102. For example, it could be a MP3 player, an Internet audio, a web browser, etc. In one embodiment, the media will be played on whatever output device is selected by the user. This output device selection may be under control of the O/S 750. For example, the O/S 750 may provide for a pop-up window that allows the user to select the output device. One or more of the media nodes 104 may appear as selections. By simply selecting one of the media nodes 104, the media signal associated with the audio application is sent from the media source device 102 to the selected media node 104 over network interface 722B. In one embodiment, the media library 752 is used to decode the media. The media library sends the decoded media to the network media driver 754, which sends the media signal to the selected output device. If the media node 104 is selected as the output device, the media signal is sent over network interface 722B. In one embodiment, the network media driver 754 is a Bluetooth driver. However, network media driver 754 may be compliant with any protocol.

Note that with the foregoing embodiment, the virtual media application 740 never touches the media signal. This has the advantage that any media source application 742 may be used when sending the media signal to the media node 104 simply by selecting the appropriate output device for the media source device 102. Thus, one embodiment of a virtual network media application is compatible with any media source applications 742. Moreover, no changes are required of to the media source application 742.

As has been previously discussed, one embodiment of a gateway media node 104 has the ability to perform any needed reformatting and processing of the media signal so that it is compatible with the virtual media network. Thus, the gateway media node 104 offloads much of the processing from the media source device 102.

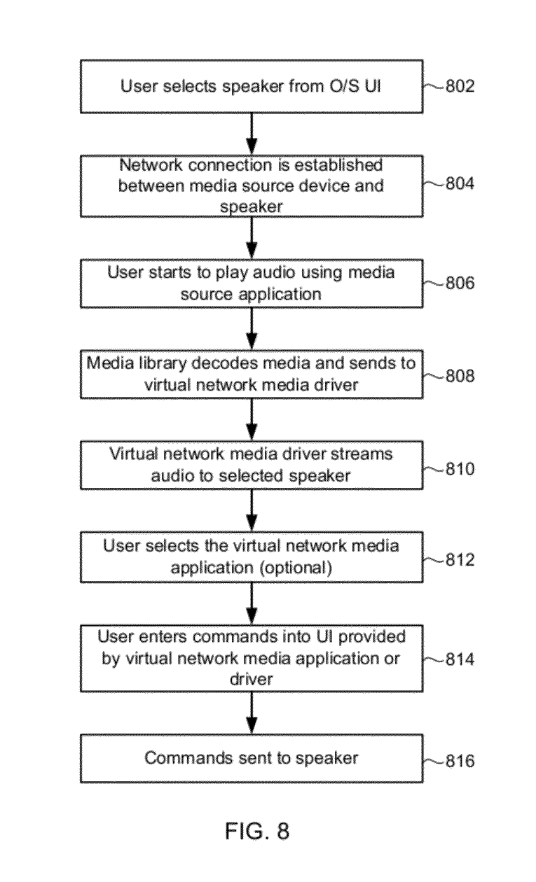

FIG. 8 is a flowchart of one embodiment of sending a media signal and commands from a media source device 102 to a media node 104. FIG. 8 will be discussed with respect to elements of FIG. 7B. However, FIG. 7B is not limited to the process of FIG. 8. Also, the process of FIG. 8 is not limited to the device of FIG. 7B. In step 802, the user selects a speaker from a user interface provided by the O/S. As one example, the media source device 102 may be able to locate Bluetooth devices in the area. Note that each speaker may store its own name. This name could have been provided to the speaker when the user first started to use the speaker. The speaker may provide this name to the O/S. The O/S may provide the ability to select one of these Bluetooth devices as an output device to play a media signal. However, note that a protocol other the Bluetooth may be used.

In step 804, a network link is established between the media source device 102 and the selected speaker using network interface 722B. Note that this link may be established at the O/S/level.

In step 806, the user begins to play audio using the media source application 742. In step 808, the media library 752 decodes the audio and sends it to the network media driver 754. In step 810, the network media driver 754 streams the audio to the selected speaker over network interface 722B. In one embodiment, the audio is the audio portion of an audio-video signal. The video signal may be played on the media source device 102 (e.g., tablet computer). Note that the audio signal may be kept in sync with the video signal.

In step 812, the user selects the virtual network media application 740. In step 814, a link is established between the media source device 102 and the speaker using network interface 722A. The virtual network media application 740 may initiate this link. In one embodiment, the authentication protocol of FIG. 5B is performed to assure that the speaker to be linked is allowed to be in the virtual network.

In order to identify the proper speaker in step 814, in one embodiment, the virtual network media application 740 queries the O/S using an API to determine which speaker the user is presently streaming audio to. In one embodiment, the virtual network media application 740 asks the user for the name of the speaker that they are presently streaming audio to. Since the speaker stores its name, the virtual network media application 740 can learn that when it receives state information from media nodes (e.g., step 504, FIG. 5A).

In step 816, the user enters commands into a UI that is provided by the virtual network media application 740. These commands could be to add new speakers, control the volume, send commands such as “play,” “pause,” “rewind”, etc. Note that commands may be entered in many ways such as checking a box, moving a slider, using a remote control, etc. In step 818, the commands are sent to the speaker using network interface 722A.

Note that although FIG. 8 is described with respect to audio, other media such as video may be used. Also note that steps of FIG. 8 might be performed in a different order. For example, the user might first bring up the virtual network media application 740 and select a speaker, in step 812. Afterwards, the user might start playing audio using the media source application, in step 806. Then, the user might select a speaker to stream the audio to, in step 802. Other possible sequences exist.

FIG. 7C is one embodiment of a media source device 102 in which both the audio signal and the commands are sent using the same network interface 722. In this embodiment, there is a virtual network media driver 784 installed in the O/S 750. The user may install this driver 784 to aid in sending the media signals to the media nodes 104. When the user desires to have the media signal sent to a media node 104, the user simply selects the media node in an interface presented by the O/S 750. This selects the virtual network media driver 784. For example, the media signal is provided to the virtual network media driver 784 from the media library 752. As with a previous example, the media source application 742 may be any application that is used for playing media.

The virtual network media application 740 may be similar to the one described in FIG. 7B. For example, it may provide an interface for the user to select media nodes to add to the virtual network, and to control the network. However, the virtual network media application 740 is optional in one embodiment, as its functionality may be incorporated into the virtual network media driver 784.

In this embodiment, a command channel is used to send commands using network interface 720. A data channel may be used to send the media signal using network interface 720. In one embodiment, the network interface 720 is compliant with Wi-Fi. However, the network interface 720 could be compliant with another protocol. Moreover, it is not required that the commands and data be sent using the same network protocol.

Note that by having a driver in the O/S, media signals from any media source application 742 may be sent to the media node 104. All the user needs to do is to select one of the media nodes 104. In response, the virtual network media driver 784 is used. Therefore, the virtual media network can be used with any media source application 742 that runs on the media source device 102.

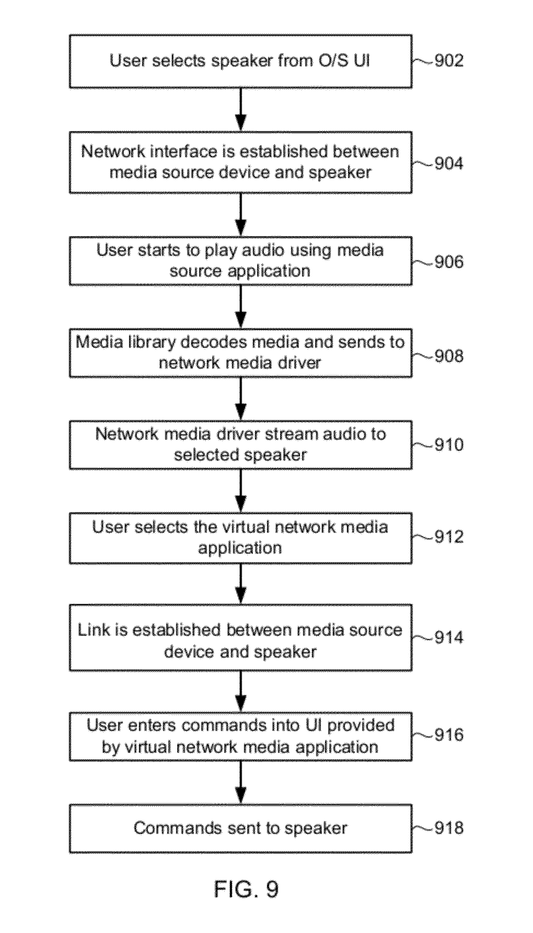

FIG. 9 is a flowchart of one embodiment of sending a media signal and commands from a media source device 102 to a media node 104. FIG. 9 will be discussed with respect to elements of FIG. 7C. However, FIG. 7C is not limited to the process of FIG. 9. Also, the process of FIG. 9 is not limited to the device of FIG. 7C. In step 902, the user selects a speaker from a user interface provided by the O/S 750. For example, the O/S 750 may provide a list of output devices that are available. This could be provided by the user selecting a speaker icon in a tray; however, many other possibilities exist.

In step 904, a network link is established between the media source device 102 and the selected speaker using network interface 722. In one embodiment, the virtual network media driver 784 initiates this link. In one embodiment, the authentication protocol of FIG. 5B is performed to assure that the device to be linked is allowed to be in the virtual media network.

In step 906, the user begins to play audio using the media source application 742. In step 908, the media library 752 decodes the audio and sends it to the virtual network media driver 784. In step 910, the virtual network media driver 754 streams the audio to the selected speaker over network interface 722. In one embodiment, the audio is sent using Wi-Fi, although another protocol may be used. In one embodiment, the audio is the audio portion of an audio-video signal. The video signal may be played on the media source device 102 (e.g., tablet computer). Note that the audio signal may be kept in sync with the video signal.

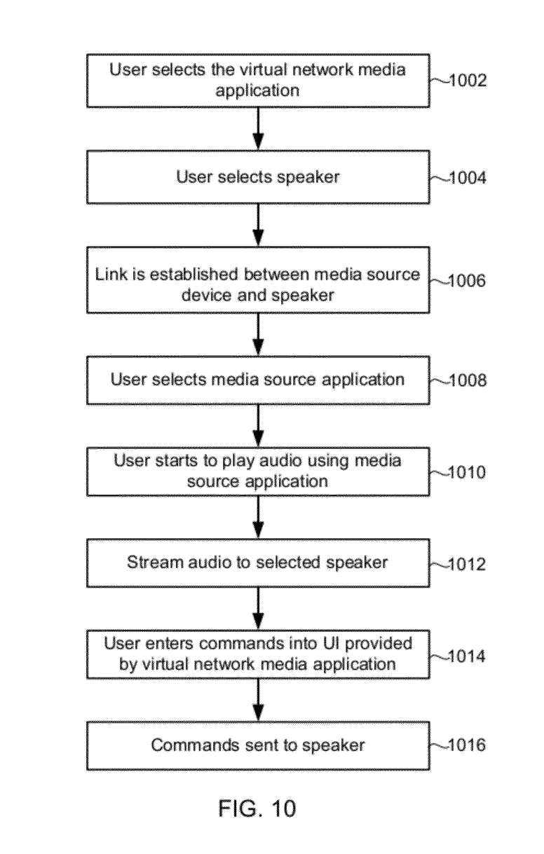

In optional step 912, the user selects the virtual network media application 740. In step 914, the user enters commands into a UI that is provided by either the virtual network media application 740 or the virtual network media driver 784. These commands could be to add new speakers, control the volume, send commands such as “play,” “pause,” “rewind”, etc. In step 916, the commands are sent to the speaker using network interface 722. In one embodiment, this is the same communication link that was established by the virtual network driver 784. However, another communication link could be established. There may be two channels associated with the communication link such that the audio signal and commands are sent on separate channels. Note that steps of FIG. 10 could be performed in a different order.

FIG. 7D depicts a block diagram of one embodiment of a media source device 102 in which a media source application 742 is embedded into the virtual network media application 740. Any media that is played by the media source application 742 may be sent to a media node 104. The network interface 722 is compliant with Wi-Fi in one embodiment. However, the network interface 722 may be compliant with any network protocol. In one embodiment, commands are sent over one channel and the media signal over a second channel.

FIG. 10 is a flowchart of one embodiment of sending a media signal and commands from a media source device 102 to a media node 104. FIG. 10 will be discussed with respect to elements of FIG. 7D. However, FIG. 7D is not limited to the process of FIG. 10. Also, the process of FIG. 10 is not limited to the device of FIG. 7D. In step 1002, the user selects the user selects the virtual network media application 740. In step 1004, the user selects a speaker from a user interface provided by the virtual media application 740. In step 1006, a network link is established between the media source device 102 and the selected speaker using network interface 722A. In one embodiment, the virtual network media application 740 initiates this link. In one embodiment, the authentication protocol of FIG. 5B is performed to assure that the device to be linked is allowed to be in the virtual media network.

In step 1008, the user selects the media source application 742 that is embedded within the virtual network media application 740. In step 1010, the user begins to play audio using the media source application 742. In step 1012, audio is streamed to the selected speaker over network interface 722A. In one embodiment, the audio is the audio portion of an audio-video signal. The video signal may be played on the media source device 102 (e.g., tablet computer). Note that the audio signal may be kept in sync with the video signal.

In step 1014, the user enters commands into a UI that is provided by the virtual network media application 740. These commands could be to add new speakers, control the volume, send commands such as “play,” “pause,” “rewind”, etc. In step 1016, the commands are sent to the speaker using network interface 722A. In one embodiment, this is the same communication link that was established in step 1006. However, another communication link could be established. There may be two channels associated with the communication link such that the audio signal and commands are sent on separate channels. Note that steps of FIG. 10 could be performed in a different order.

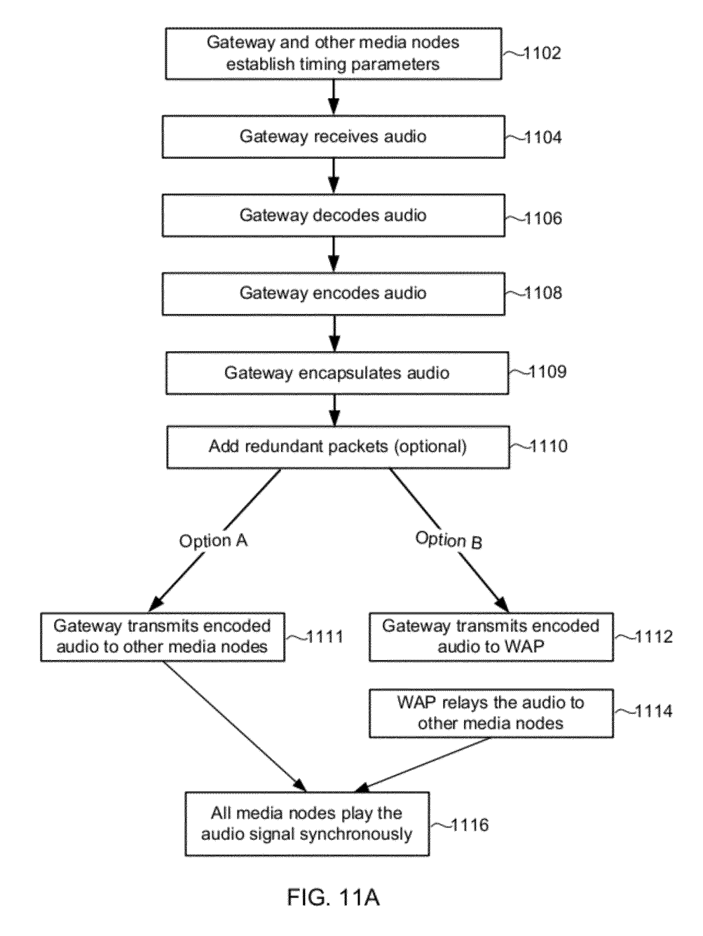

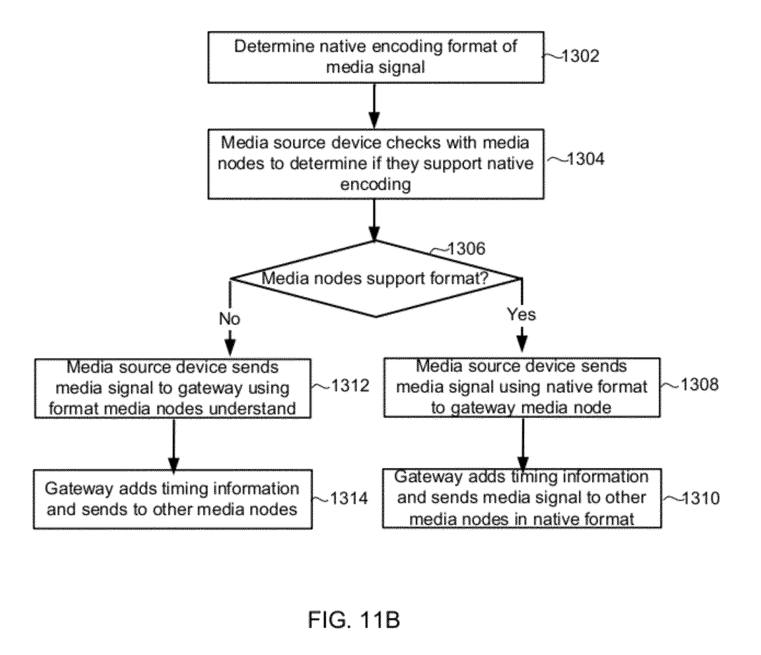

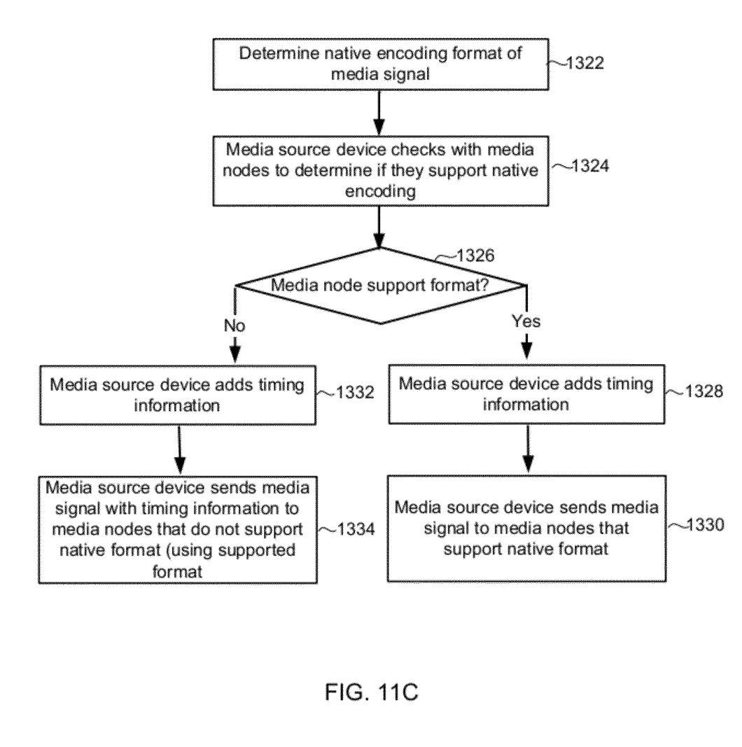

FIG. 11A is a flowchart of one embodiment of a gateway media node 104 forwarding audio on to other media nodes 104. FIG. 11A is one embodiment of step 210 from FIG. 2. In step 1102, the gateway media node 104 and the other media nodes establish timing parameters. In one embodiment, the gateway media node 104 sends a signal to another media node 104, which is responded to with a reply. The gateway media node 104 is able to determine how much timing delay there is between the speakers, factoring in delays in processing by circuitry with the nodes 104. This process may be repeated many times, such that an average delay may be computed.

In one embodiment, all media nodes 104 synchronize to a virtual wall clock. The virtual wall clock may be used by the broadcaster 304 to timestamp the media stream with the intended render time. The virtual wall clock may be used by renderers 306 to precisely render the media samples at given time. The virtual wall clock ensures that all media nodes 104 have a common understanding of render time. In one embodiment, each rendering device 306 renders samples at the time specified in the media stream. Other information for the rendering of the stream may also be included in the stream format including sampling frequency, word size, number of channels, encoding format, etc.

In step 1104, the gateway media node 104 receives an audio signal from the media source device 102. In step 1106, the gateway media node 104 decodes the audio. The gateway may de-multiplex the audio signal prior to decoding.

In step 1108, the gateway media node 104 re-encodes the audio for broadcast to other media nodes 104. Note that the gateway may use a different encoding than the media source device used. For example, the audio signal may have been encoded at the media source device in a format that is compatible with Bluetooth. It may be re-encoded in a format that is compatible with Wi-Fi.

In step 1109, the gateway media node 104 encapsulates the audio signal. In one embodiment, the gateway media node 104 compresses the audio signal. As an example, in high quality networks, a light lossless compression technique such as Free Audio Lossless Codec (FLAC) can be used to cut bandwidth in half with minimal processing overhead. In low quality networks, a higher compression standard such as OGG or Advance Audio Coding (AAC) can be used to minimize network bandwidth at the expense of sound quality and processing overhead. Beyond the compression algorithm itself, the signal can resampled to a lower sampling rate, down-mixed to a mono stream, or down-sampled to a lower sample resolution. Encoding or transcoding the media stream to a compressed form can improve airtime reliability by using less network bandwidth at the expense of processing overhead. Supported codecs can include lossless and lossy compression techniques of various bitrates, sampling frequencies, channels, and sample sizes.

All media nodes 104 are cognizant of the supported encoding formats, in one embodiment. All broadcasters 304 are capable of encoding into the supported formats, in one embodiment. All renderers 306 are capable of decoding the supported formats, in one embodiment. The encoding format that is used for each stream may be determined among the media nodes 104 with feedback from network quality, available processing resources, the number of rendering zones being supported, the number of active streams being supported, and the maximum acceptable latency.

In optional step 1110, redundant packets are added. If the audio signal has been compressed, additional packets may be added. In one embodiment, a group of packets is interleaved with a group of redundant packets. For example, with a 2:1 compression ratio, two seconds of the original audio signal may be compressed to one second. As one example, one second worth of (compressed data) packets may be interleaved with one second of redundant packets. The number of packets in a group could be one or higher.

Broadcasting has two options in one embodiment. In option A, the gateway media node 104 broadcasts the audio signal to other media nodes 104 (step 1111). In option B, the gateway media node 104 sends the audio signal to a wireless access point 310 (step 11112). The wireless access point 310 broadcasts the audio signal to other media nodes in step 1114.

Broadcast media may be the largest consumer of network bandwidth. Typical uncompressed audio streams can exceed over 1.5 mbps. Transmission can consume 1.5 mbps per stream up to the access point 310 and an additional 1.5 mbps per stream down to the renderer 306 for a total of 3 mbps. For point-to-point simulcasting, the typical bandwidth may be 3 mbps times the number of simulcast streams. This has the potential for saturating the network.

Embodiments support multiple transmission protocols. In one embodiment, UDP over IP is used. Note that in one embodiment, the receiving media node is not required to acknowledge reception of packets. For example, UDP over IP may not require reception of packets. In one embodiment, the receiving media node requests the gateway to re-send a data packet that is not received. Note that this may occur in an embodiment that uses UDP over IP. As mentioned above, in one embodiment, redundant data packets are sent.

Network statistics may be maintained by media nodes 104. The elected broadcaster 304 or gateway is responsible for determining the best transmission methods to balance quality of service, latency, processor utilization, and network utilization, in one embodiment. For example if the network is of good quality, with high available bandwidth and strong connections to individual nodes 104, a guaranteed transmission protocol can be used. If the network is saturated or of lower quality, a multicasting technique may be preferable. Additional methods can help conserve bandwidth, and detect, correct or conceal transmission errors. In general, multicasting, simulcasting and point-to-point protocols are supported with the most suitable protocol determined at the time of stream construction with network quality, available processing power, and the number of streams being contributing factors in the decision process.

In step 1116 all of the media nodes 104 in the virtual media network synchronously play the audio signal. In one embodiment, a renderer 306 de-muxes and decodes the stream and renders at the time specified in the encapsulation. Note that the gateway device itself could save an already de-muxed version of the media signal such that it does not need to de-mux again. In one embodiment, the gateway node 104 sends the stream to itself in the form of a rendering thread.

In one embodiment, the audio is the audio portion of an audio-video signal. The video signal may be played on the media source device 102 (e.g., tablet computer). Note that the audio signal may be kept in sync with the video signal.

The media clock may be recovered through the media stream with reference to the wall clock and may be synchronized to media frames or groups of samples. The media clock drives the formation of the hardware frame clocks, word clocks and bit clocks. Synchronizing via the media stream guarantees accurate clocks can be generated at the media nodes 104 from a logical viewpoint. Slight variations in hardware, such as with crystals, can cause clock drift and other variances in clock timing. Constant measurement and comparison of the media clock and wall clock allows the system to detect drift. In one embodiment, a software-only media clock recovery mechanism involves adding or removing media samples to and from the media rendering buffers to re-sync media clocks across devices. In one embodiment, the rendering buffer manipulation is done in a way that does not cause the effects of obvious clicking or skipping. A hardware mechanism, using VCXOs, or voltage controlled oscillators, can be controlled from the processor based on drift measurements and push or pull the hardware oscillators into tighter synchronization.

Depending on the stream format, errors can occur. Sources of errors include lost packets, out-of-order packets, or packets that arrive after the time-stamped play time. Renderers 306, in conjunction with broadcasters 304, can provide different methods to conceal and/or prevent errors.

In multicast sessions, errors can be detected when a packet does not arrive by comparing the sequence numbers of arrived packets. If a packet is lost during a multicast transmission, a renderer 306 can send a negative acknowledgement to the broadcaster 304 and ask for retransmission of a given packet. If not enough time is available for a re-transmit (acceptable latency) or network bandwidth does not allow retransmission, the renderer 306 can conceal the error by muting the audio output during the affected render time, or re-forming the audio signal through signal processing techniques such as filtering.

If packets arrive out of order, the renderer 306 can re-order arrived packets prior to output to the audio device. This may be dependent on the pre-determined network latency.

If a particular broadcaster-renderer link is poor, the link has the potential of affecting the quality of all of the links in the network. Constant re-transmissions, and re-measurement of network performance consume bandwidth and may add unnecessary latency and processor burden. In bad network environments, guaranteed delivery links such as TCP/IP can be used to ease processor utilization at the expense of greater bandwidth utilization. These links essentially prevent error cases from happening in the airtime rendering subsystem. Note that TCP-IP is not required. Alternatively, where network bandwidth is plentiful, this method can be used as the standard broadcast method.

In some embodiments, a longer acceptable rendering latency can be negotiated between the media nodes 104 to deliver higher QoS. This latency can be changed mid-stream or at the start of stream construction. Latency improves QoS by allowing more time for correction or concealment mechanisms to take effect. In some cases, such as with audio synchronization with games or video, only lower latencies are tolerable even if a higher error rate results.

The network media driver 754, virtual network media driver 784, virtual network media application 740, or other O/S driver or application can transmit the media signal (e.g., audio) in many formats. In one embodiment, the media signal is transmitted from the media source node 102 using raw PCM. In one embodiment, e media signal is transcoded to a generic format such as FLAC. In one embodiment, the network media driver 754, virtual network media driver 784, virtual network media application 740, or other O/S driver or application intelligently elects to use the native source format. For example, if the source file is an MP3, the code on the media source node 102 can elect to send the MP3 as a stream to the gateway media node 104 and the gateway media node 104 can rebroadcast the MP3 to rendering media nodes (after the gateway instruments the signal timing).

FIG. 11B is a flowchart of one embodiment of a media source node sending the media signal to the gateway using the native format of the media signal. In step 1302, the media source node 102 determines that native format of the media signal. In step 1304, the media source node 102 checks with the media nodes 104 in the virtual media network to determine whether they are able to support the native format. The gateway may have the information for all media nodes in the virtual media network. If the media nodes support the native format (step 1306), then the media source node 102 sends the media signal to the gateway media node 104 using the native format, in step 1308. The gateway media node 104 adds timing information and sends the media signal to the other media nodes using the native format, in step 1310. If the media nodes do not support the native format (step 1306), then the media source node 102 sends the media signal to the gateway media using some format that is understood by the media nodes 104. For example, the media signal might be sent using PCM or FLAC.

In one embodiment, the network media driver 754, virtual network media driver 784, virtual network media application 740, or other O/S driver or application can instrument the native format and send it directly to rendering media nodes 104. This saves the transcoding that would otherwise happen in the gateway media node 104 or media source device 102, and will generally use less bandwidth. FIG. 11C is a flowchart of one embodiment in which the media source device 102 instruments the native form a with timing information. In step 1322, the media source device 102 checks with the media nodes 104 (e.g., renderers and/or gateways) to determine whether the native encoding format could be decoded on that device.

In step 1326, the media source node 102 determines whether to send using native format or another format that is supported by the media node 104. If a media source device 102 supports the native format, then timing information is added by the media source device (step 1328) and the media source device 102 sends the media signal to the media nodes that support the native format 104 (step 1330). In OS architectures there may be media decode facilities (e.g., DirectShow, or OpenCore, or gStreamer) that the application pumps a stream or file data to. The functionality may be modified at this level to selectively transcode or bypass and transmit through the driver. If the format is not supported by a media node 104, raw PCM or transcoding to a supported format like FLAC could be done. This is depicted as steps 1322 and 1334.

In one embodiment, an audio signal that is played in the virtual media network is synchronized to a video signal. As one example, the media source device 102 provides the video portion of an audio-visual signal to a display. The audio portion of the signal is sent to the gateway media node 104, which broadcasts it to other media nodes 104 in the virtual media network.

The display could be any device. The display could be a part of the media source device 102. Alternatively, the video signal could be sent wirelessly or by wireline to a display or device having a display. The display may or may not be associated with a node in the virtual media network. As examples, the display could be a tablet computer, television, cellular telephone, etc.

In one embodiment, synchronizing audio to video includes having a render time for video and a render time for audio. The video render time is used to control when the video is rendered on the display. The media source device 102 may send the audio render time to the gateway media node. Therefore, the audio may be kept synchronized with the video. The audio render time may be used to allow multiple media nodes 104 to play the audio in synchronization with the video.

FIG. 12 illustrates a high level block diagram of a computer system which can be used to implement any of the devices described above. The computer system of FIG. 12 includes one or more processors 550 and main memory 552. Main memory 552 stores, in part, instructions and data for execution by processor unit 550. If the system of the present invention is wholly or partially implemented in software, main memory 552 can store the executable code when in operation. The system of FIG. 8 further includes a mass storage device 554, peripheral device(s) 556, user input device(s) 560, output devices 558, portable storage medium drive(s) 562, a graphics subsystem 564 and an output display 566. For purposes of simplicity, the components shown in FIG. 8 are depicted as being connected via a single bus 568. However, the components may be connected through one or more data transport means. For example, processor unit 550 and main memory 552 may be connected via a local microprocessor bus, and the mass storage device 554, peripheral device(s) 556, portable storage medium drive(s) 562, and graphics subsystem 64 may be connected via one or more input/output (I/O) buses. Mass storage device 554, which may be implemented with a magnetic disk drive or an optical disk drive, is a non-volatile storage device for storing data and instructions for use by processor unit 550. In one embodiment, mass storage device 554 stores the system software for implementing the present invention for purposes of loading to main memory 552.

Portable storage medium drive 562 operates in conjunction with a portable non-volatile storage medium, such as a floppy disk, to input and output data and code to and from the computer system of FIG. 12. In one embodiment, the system software for implementing the present invention is stored on such a portable medium, and is input to the computer system via the portable storage medium drive 562. Peripheral device(s) 556 may include any type of computer support device, such as an input/output (I/O) interface, to add additional functionality to the computer system. For example, peripheral device(s) 556 may include a network interface for connecting the computer system to a network, a modem, a router, etc.

User input device(s) 560 provides a portion of a user interface. User input device(s) 560 may include an alpha-numeric keypad for inputting alpha-numeric and other information, or a pointing device, such as a mouse, a trackball, stylus, or cursor direction keys. In order to display textual and graphical information, the computer system of FIG. 12 includes graphics subsystem 564 and output display 566. Output display 566 may include a cathode ray tube (CRT) display, liquid crystal display (LCD) or other suitable display device. Graphics subsystem 564 receives textual and graphical information, and processes the information for output to display 566. Additionally, the system of FIG. 8 includes output devices 558. Examples of suitable output devices include speakers, printers, network interfaces, monitors, etc.

The components contained in the computer system of FIG. 12 are those typically found in computer systems suitable for use with the present invention, and are intended to represent a broad category of such computer components that are well known in the art. Thus, the computer system of FIG. 8 can be a cellular telephone, smart phone, PDA, tablet computer, personal computer, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The technology described above can be implemented using hardware, software, or a combination of both hardware and software. The software is stored on one or more processor readable storage devices including hard disk drives, CD-ROMs, DVDs, optical disks, floppy disks, tape drives, RAM, ROM, flash memory, or other suitable storage devices. The software is used to program one or more processors to perform any of the processes described herein. In alternative embodiments, some or all of the software can be replaced by dedicated hardware including custom integrated circuits, gate arrays, FPGAs, PLDs, and special purpose computers.

One embodiment includes a method for distributing media, comprising the following. A media source device receives state information that describes media nodes that are potentially available to form a virtual media network. One or more selections of one or more media nodes that are to form a virtual media network are received. A first of the media nodes in the virtual media network that is selected as an output device in an operating system interface is instructed to forward a media signal that the first media node receives from the media source device to other media nodes in the virtual media network.

One embodiment includes a network device, comprising a first network interface for receiving a media signal from a media source device using a first network protocol, a second network interface for receiving a media signal from a media source device using a second network protocol, and a broadcaster for transmitting media signals received from both the first network interface and the second network interface to another device using the second network protocol.

One embodiment includes one or more processor readable storage devices having processor readable code embodied on said processor readable storage devices, said processor readable code for programming one or more processors to perform a method comprising the following steps. A media source device receives state information that describes media nodes that are potentially available to form a virtual media network. A first of the media nodes is established as a gateway media node. The gateway media node is requested to link to one or more of the media nodes that are to form a virtual media network with the gateway media node. The first media node serves an output device in an operating system interface while acting as the gateway media node.

One embodiment includes a method comprising the following. A first media signal is received at a first network media node from a media source device using a first network protocol. A command signal for the first media signal is received at the first network media node from the media source device using a second network protocol. The command signal specifies other network media nodes to receive the first media signal and commands for rendering the first media signal. The first media signal is broadcast to the other network media nodes using the second network protocol. The commands are sent to the other network media nodes using the second network protocol.

One embodiment includes a method comprising the following. Media is injected into a network from a media source device. The network including a plurality of media nodes. A first of the media nodes is selected to serve as a gateway for the network based on its status as an active output device for the media source device. Media distribution is controlled at the first media node, including re-broadcasting the media from the first media node to media nodes that are actively rendering the media, and maintaining precise timing synchronization of rendering the media at the media nodes.

The foregoing detailed description has been presented for purposes of illustration and description. It is not intended to be exhaustive or to limit embodiments to the precise form disclosed. Many modifications and variations are possible in light of the above teaching. The described embodiments were chosen in order to best explain the principles and practical applications to thereby enable others skilled in the art to best utilize the various embodiments and with various modifications as are suited to the particular use contemplated. It is intended that the scope be defined by the claims appended hereto.

We claim:

1. A method for distributing media, comprising:
receiving, by a media source device, state information that describes media nodes that are potentially available to form a virtual media network;
receiving one or more selections of one or more media nodes that are to form a virtual media network; and
instructing a first of the media nodes in the virtual media network that is selected as an output device in an operating system interface to forward to other media nodes in the virtual media network a media signal that the first media node receives from the media source device.

2. The method of claim 1, further comprising:
creating connections to the one or more media nodes to allow multi-room streaming of the media signal at the operating system level.

3. The method of claim 1, wherein the instructing the first media node includes:
sending one or more commands to the first media node using a first network interface on the media source device, the commands for controlling and distributing the media signal in the virtual media network.

4. The method of claim 3, wherein the first network interface is different from a second network that is used to send the media signal to the first media node.

5. The method of claim 4, wherein the first network interface uses a first communication protocol, the second interface uses a second communication protocol.

6. The method of claim 1, further comprising:
querying the operating system as to which device has been selected as the output device; and
establishing the first media node as a gateway for the virtual media network in response to the operating system indicating that the first media device was selected as the output device.

7. The method of claim 6, wherein the querying and the establishing are performed by an application executing on the media source device.

8. The method of claim 1, further comprising:
receiving the media signal at a device driver in the operating system; and
transmitting the media signal to the first media node, the instructing is performed by the device driver.

9. The method of claim 1, wherein the media signal is an audio signal that is associated with a video signal being presented on the media source device, further comprising:
instructing the media nodes in the virtual media network to play the audio signal in sync with the video signal.

10. A network device, comprising:
a first network interface for receiving a media signal from a media source device using a first network protocol;
a second network interface for receiving a media signal from a media source device using a second network protocol; and
a broadcaster for transmitting media signals received from both the first network interface and the second network interface to another device using the second network protocol.

11. The network device of claim 10, wherein the first network protocol is Bluetooth.

12. The network device of claim 11, wherein the second network protocol is Wi-Fi.

13. The network device is claim 10 further comprising:
logic that de-multiplexes a first audio stream that is received on the first network interface, transcodes the first audio stream, re-multiplexes the transcoded first audio stream into a second audio stream, the broadcaster transmits the second audio stream using the second network interface.

14. The network device is claim 10, further comprising:
logic that transcodes and compresses the media signal received from the media source device to produce an output media signal having packets, the broadcaster interleaves a group of the packets with a redundant group of the packets.

15. The network device of claim 10, further comprising a rendering device coupled to the first and second network interfaces, the rendering device for rendering media signals received over the first and second networks.

16. The network device of claim 10, further comprising logic that receives device status from network media nodes, maintains state information based on the received device status, and sends the state information to a device that serves as a media source for a virtual media network, the network device serves as a gateway for the virtual media network.

17. The network device of claim 16, wherein the device status for each of the network media nodes includes an indication of whether the network media node is paired to a device that serves as an audio source for a virtual media network.

18. The network device of claim 16, wherein the device status for each of the network media nodes includes an indication of whether the network media node is serving as a gateway device for a virtual media network.

19. The network device of claim 16, wherein the device status for a given network media node includes an indication of whether the given network media node is an active node in a virtual media network and, if so, an identification of the virtual media network of which it is an active node.

20. One or more processor readable storage devices having processor readable code embodied on said processor readable storage devices, said processor readable code for programming one or more processors to perform a method comprising the steps of:
receiving, by a media source device, state information that describes media nodes that are potentially available to form a virtual media network;
establishing a first of the media nodes as a gateway media node; and
requesting that the gateway media node link to one or more of the media nodes that are to form a virtual media network with the gateway media node, the first media node serves an output device in an operating system interface of the media source device while acting as the gateway media node.

21. The one or more processor readable storage devices of claim 20, further comprising:
sending one or more commands for controlling the virtual media network to the first media node using a first network communication protocol, the first network communication protocol is different from a second network communication protocol that is used to send a media signal to the first media node that is to be rendered in the virtual media network.

22. The one or more processor readable storage devices of claim 20, further comprising:
querying the operating system as to which device has been selected as the output device, the establishing the first media node as a gateway is performed in response to the operating system indicating that the first media device was selected as the output device.

23. The one or more processor readable storage devices of claim 20, further comprising:
establishing, by the gateway media node, communication links with the one or more media nodes that are to form the virtual media network to allow streaming of a media signal at a level of the operating system of the of the media source device.

24. A method, comprising:
receiving a first media signal at a first media node from a media source device using a first network protocol;
receiving a command signal for the first media signal at the first media node from the media source device using a second network protocol, the command signal specifying other media nodes to receive the first media signal and commands for rendering the first media signal;
broadcasting the first media signal to the other network media nodes using the second network protocol; and
sending commands for rendering first media signal from the first media node to the other media nodes using the second network protocol.

25. The method of claim 24, further comprising:
de-multiplexing the first media signal that is received at the first media node;
transcoding the first media signal; and
re-multiplexing the transcoded first media signal, the broadcasting the first media signal includes transmitting the transcoded and re-multiplexed first media signal.

26. The method of claim 24, further comprising:
transcoding the media signal received from the media source device; and
compressing the transcoded media signal to produce an output media signal having packets, the broadcasting the first media signal includes interleaving a group of the packets with a redundant group of the packets.

27. The method of claim 24, further comprising:
requesting, by one of the other media nodes to the first media node, that a packet in the first media signal be resent, the broadcasting the first media signal includes using a protocol that does not require acknowledgement of reception of packets.

28. The method of claim 24, further comprising:
receiving device status from the other media nodes at the first media node;
maintaining state information at the first media node based on the received device status; and
sending the state information to the media source device, the first media node serves as a gateway for a virtual media network that includes the first media node and the other media nodes.

29. A method comprising:
injecting media into a network from a media source device, the network including a plurality of media nodes;
selecting a first of the media nodes to serve as a gateway for the network based on its status as an active output device for the media source device;
controlling media distribution at the first media node, including:
re-broadcasting the media from the first media node to media nodes that are actively rendering the media; and
maintaining precise timing synchronization of rendering the media at the media nodes.

30. The method of claim 29, wherein the injecting media is performed by one of:
a cell phone, tablet, stereo, set-top box, or personal computer.

31. The method of claim 29, wherein:
the plurality of end point rendering devices include a stereo, a speaker, a television, a computer, and a monitor.
